(19) United States
(12) Patent Application Publication
(10) Pub. No.: US 2025/0011179 A1
(43) Pub. Date: Jan. 9, 2025

(54) METHOD AND APPARATUS FOR PRODUCING AMMONIA

(71) Applicant: Linde GmbH, Pullach (DE)

(72) Inventors: Josef SCHWARZHUBER, Pullach (DE); Albrecht HEINZEL, Pullach (DE); Michael REINKE, Pullach (DE)

(21) Appl. No.: 18/712,092

(22) PCT Filed: Nov. 2, 2022
(86) PCT No.: PCT/EP2022/025491

§ 371 Date: May 21, 2024

(30) Foreign Application Priority Data
Nov. 26, 2021 (EP) 21020596.9

(51) Int. Cl. C01C 1/04; C01B 3/04; C25B 1/04; C25B 15/08

(52) U.S. Cl. CPC C01C 1/047; C01B 3/047; C01C 1/0452; C01C 1/0482; C25B 1/04; C25B 15/081; C01B 2203/0277; C01B 2203/068

(57) ABSTRACT

A method and an apparatus for producing ammonia, in which a first hydrogen/nitrogen fraction is provided at a time-varying flow rate in order to form an ammonia synthesis gas which is converted to ammonia in an ammonia synthesis, wherein the first hydrogen/nitrogen fraction is supplemented by a second hydrogen/nitrogen fraction in such a way that, during normal operation, the ammonia synthesis gas can always be supplied to the ammonia synthesis at a flow rate which exceeds a predefined minimum value. The characterizing feature is that ammonia produced in the ammonia synthesis is transferred in liquid form to a storage means from which ammonia is taken and split into hydrogen and nitrogen in order to obtain hydrogen and nitrogen so as to form the second hydrogen/nitrogen fraction.

The invention relates to a method for producing ammonia, in which a first hydrogen/nitrogen fraction is provided at a time-varying flow rate in order to form an ammonia synthesis gas which is converted to ammonia in an ammonia synthesis, wherein the first hydrogen/nitrogen fraction is supplemented by a second hydrogen/nitrogen fraction in such a way that, during normal operation, the ammonia synthesis gas can always be supplied to the ammonia synthesis at a flow rate which exceeds a predefined minimum value.

The invention also relates to an apparatus for carrying out the method according to the invention.

Normal operation is to be understood as a mode in which the ammonia synthesis delivers ammonia of a defined quality in a quantity that can vary between a minimum and a maximum value, but is always different from zero. The start-up and shut-down as well as the standstill of the ammonia synthesis are not part of the normal operation.

Ammonia is one of the most widely produced chemicals in the world. It is primarily used as a raw material for the production of fertilizers, but is also becoming increasingly important as an energy source and hydrogen storage means. On an industrial scale, using the Haber-Bosch process, it is synthesized almost exclusively from nitrogen, which is separated cryogenically or adsorptively from air, and hydrogen. Depending on whether, as is still very typical today, large quantities of climate-damaging carbon dioxide are released when hydrogen and nitrogen are produced or whether they are produced largely without carbon dioxide, the terms used are “gray ammonia” or “green ammonia”.

In the Haber-Bosch process, an ammonia synthesis gas consisting mainly of hydrogen and nitrogen in which the two substances are present in a stoichiometric ratio of 3:1 for the synthesis of ammonia, is supplied to an ammonia synthesis process at a pressure of between 100 and 200 bar(a) in order to be converted exothermically to ammonia with catalytic support in an ammonia reactor. However, thermodynamic limitations render the conversion incomplete resulting in a gas mixture that contains considerable amounts of hydrogen and nitrogen in addition to ammonia. At a temperature between 400 and 450° C., this gas mixture leaves the ammonia reactor and is subsequently cooled in a series of heat exchangers to separate ammonia by condensation and obtain a recycle gas consisting largely of hydrogen and nitrogen and containing residues of non-separated ammonia, which is recycled to increase the ammonia yield and is used in the formation of the ammonia synthesis gas.

To produce “green ammonia”, hydrogen is obtained largely free of carbon dioxide, for example by breaking down water using an electrolyzer, and mixed with nitrogen, which is also produced largely free of carbon dioxide, to form a first hydrogen/nitrogen fraction, which is used with a defined hydrogen/nitrogen ratio to form the ammonia synthesis gas. The electrical power for electrolysis and nitrogen production is obtained directly from renewable sources, such as wind or solar power plants, or as surplus power from the public grid, which is why it is not constantly available. Since the operation of the electrolyzer can be adapted relatively easily and quickly to these conditions and the hydrogen production is proportional to the electrical power supplied in a first approximation, both the flow rate of hydrogen produced in the electrolyzer and the flow rate of the first hydrogen/nitrogen fraction fluctuate with the amount of electrical power available.

Compared to the electrolyzer and the apparatus used for nitrogen production, which is a cryogenic air separator for example, ammonia synthesis can only be adapted to fluctuating operating conditions much more slowly and within narrower limits. If the amount of ammonia synthesis gas that can be supplied falls below a minimum value, normal operation must be interrupted and ammonia synthesis switched off. To avoid this, according to the prior art, at times when sufficient electrical power is available, more hydrogen and nitrogen can be produced than can be used in ammonia synthesis. The excess substances produced are stored and, at times when there is insufficient electrical power, are used to form a second hydrogen/nitrogen fraction which supplements the first hydrogen/nitrogen fraction so that the ammonia synthesis gas can be formed at a flow rate which exceeds the minimum value and supplied to the ammonia synthesis.

Hydrogen and nitrogen are stored separately or together in gaseous form or adsorptively or adsorptively bound to suitable substances or in liquid form as pure substances in cryogenic storage. In any case, storage is cost-intensive because the required storage means must be very large and/or pressure-resistant or thermally insulated, and considerable costs are also incurred for apparatus and equipment for compressing or cooling the substances. There is also a risk that the stored quantities of substance will not be sufficient to bridge a prolonged shortage of electrical power and that ammonia synthesis will have to be switched off despite everything.

Unscheduled shutdowns and start-ups of the ammonia synthesis process should be avoided as far as possible, however, as the associated pressure and temperature changes place a heavy mechanical load on the ammonia reactor, as well as on auxiliary equipment, such as synthesis gas and refrigerant compressors. The catalyst used can decompose, reducing its activity, increasing the pressure loss across the catalyst bed and causing the gases used in the ammonia reactor to be wrongly distributed. Furthermore, during the restart of the ammonia synthesis, which can take up to two days, no ammonia can be produced for release as a product, even if hydrogen and nitrogen are already available in sufficient quantities during this time.

The object of the present invention is therefore to specify a method and an apparatus of the generic type, given which the disadvantages of the prior art can be overcome.

In accordance with the invention, the object posed is solved by transferring ammonia produced in the ammonia synthesis in liquid form to a storage means, from which ammonia is taken and split into hydrogen and nitrogen in order to obtain hydrogen and nitrogen for forming the second hydrogen/nitrogen fraction.

Liquid ammonia can be stored cost-effectively at moderate pressures and temperatures in a comparatively small space. Ammonia plants typically have ammonia storage means in which the ammonia that can be released as a product is temporarily stored in this way before it is used further, for example as an energy source. The ammonia used to form the second hydrogen/nitrogen fraction according to the invention can also be taken from such an ammonia storage means.

However, it is also possible to use a separate buffer tank which only holds the ammonia intended for the formation of the second hydrogen/nitrogen fraction according to the invention. It makes sense to store the ammonia at atmospheric pressure and temperatures around −33° C. (±5° C.) or at higher temperatures and pressures above atmospheric pressure.

Preferably, ammonia is only introduced into the buffer tank if the first hydrogen/nitrogen fraction is available with a flow rate large enough to form ammonia synthesis gas with a flow rate exceeding the minimum value and a second hydrogen/nitrogen fraction is not required. However, the process according to the invention can also be used to set up a continuous hydrogen/nitrogen cycle, whereby liquid ammonia is introduced into the buffer tank and at the same time ammonia is taken from the buffer tank to form the second hydrogen/nitrogen fraction.

Provided that sufficient ammonia is stored in the buffer tank before the continuous hydrogen/nitrogen cycle is set up in order to establish the hydrogen/nitrogen cycle with a strength sufficient to supply ammonia synthesis gas to the ammonia synthesis at a flow rate which exceeds the minimum value, it is theoretically possible to maintain normal operation of the ammonia synthesis for any length of time, regardless of the size of the first hydrogen/nitrogen fraction. In practice, losses inevitably occur in the hydrogen/nitrogen cycle, which limit the maintenance of normal operation to finite periods. Compared to the state of the art, however, these times are considerably longer for the same quantities of hydrogen stored.

To form the second hydrogen/nitrogen fraction, the ammonia taken from the storage means is supplied to a cracking reactor, where it is converted, with or without catalytic support, into a cracked gas in an endothermic reaction. The position of the equilibrium and the speed of the resulting reaction

2NH₃↔N₂+3H₂
are very much a function of pressure and temperature as well as the type of catalyst used.

Tanks, such as those used for the temporary storage of ammonia in ammonia plants, are typically made of carbon steel, which is susceptible to corrosion, which is why the ammonia to be stored is mixed with a small amount of water to suppress the corrosion mechanisms. In order to prevent this water, which is not converted in the cracking reactor, from entering the ammonia reactor via the ammonia synthesis gas, where it is a poison to the catalyst used there, it is proposed to pass the cracked gas obtained in the cracking reactor via a dryer station to form the second hydrogen/nitrogen fraction in order to separate off the water it contains. The removal of unconverted ammonia from the cracked gas can be omitted because ammonia, which enters the ammonia synthesis gas via the recycle gas anyway, is not a catalyst poison in the ammonia reactor. In addition, ammonia is usually present in the cracked gas in such a low concentration that it only insignificantly thermodynamically limits the conversion of the ammonia synthesis.

In a particularly preferred embodiment of the invention, provision is made for obtaining hydrogen for the formation of the first hydrogen/nitrogen fraction with the aid of an electrolyzer by splitting water, whereby an oxygen-rich and a hydrogen-rich material flow are produced. Regardless of the type of electrolyzer used, the hydrogen-rich material flow always contains a small amount of water, which must be removed in a dryer station downstream of the electrolyzer in order to avoid poisoning the catalyst used in the ammonia reactor. This drying station is also conveniently used to remove water from the cracked gas obtained in the cracking reactor.

If the ammonia intended for the formation of the second hydrogen/nitrogen fraction according to the invention is stored in a separate buffer tank, this tank, which is smaller than an intermediate ammonia storage means, can be made of a material that is more resistant to corrosion by ammonia without significantly increasing the plant costs. It is therefore proposed to store the ammonia free of water in such a buffer tank so that an anhydrous cracked gas is produced in the cracking reactor, which is used directly to form the ammonia synthesis gas without drying.

It makes sense to carry out ammonia cracking at a pressure that allows the cracked gas to be processed into the second hydrogen/nitrogen fraction without compression such that said fraction is present at a pressure that is higher than the intake pressure of a compressor with which the ammonia synthesis gas is brought to the inlet pressure of the ammonia synthesis. Ammonia cracking is preferably carried out at pressures between 10 and 40 bar(a). This is all the easier as the pressure of the liquid ammonia can be increased with little energy input. In order to achieve, under these conditions, a sufficiently high, economically viable degree of conversion of the ammonia used, it is necessary to run the cracking process at temperatures between 500 and 1000° C.

To obtain the second hydrogen/nitrogen fraction, it is necessary to cool the cracked gas flowing hot out of the cracking reactor. For example, the cracked gas can be used to preheat the ammonia supplied to the cracking reactor and/or to generate steam, which supplements a steam flow that is produced when the gas mixture obtained in the ammonia synthesis is cooled and which is expediently expanded via a steam turbine in order to drive a compressor or a power generator.

In addition to ammonia, hydrogen and nitrogen, the gas mixture obtained in ammonia synthesis also contains inert gases, such as argon and helium, which have to be removed from the process continuously or discontinuously in a purge gas stream. The process causes a purge gas stream to also contain combustible substances, such as ammonia and hydrogen, which is why it is underfired in conventional ammonia production, for example in a steam reformer used for hydrogen production. Since such a utilization option does not exist in the process according to the invention, it is proposed to underfire purge gas produced in the process in the cracking reactor or to dispose of it by incineration in a flare.

The invention also relates to an apparatus for producing ammonia, having a first hydrogen/nitrogen source which provides a first hydrogen/nitrogen fraction at a time-varying flow rate in order to form an ammonia synthesis gas, an ammonia synthesis to which the ammonia synthesis gas can be supplied for conversion to ammonia, and a second hydrogen/nitrogen source, which can provide a second hydrogen/nitrogen fraction in order to supplement the first hydrogen/nitrogen fraction in such a way that, during normal operation, the ammonia synthesis gas can always be supplied to the ammonia synthesis at a flow rate which exceeds a predefined minimum value.

On the apparatus side, the object posed is solved according to the invention in that it comprises a storage means connected to the second hydrogen/nitrogen source, into which ammonia produced in the ammonia synthesis can be transferred in liquid form, and from which ammonia can be supplied to the second hydrogen/nitrogen source in order to obtain hydrogen and nitrogen for forming the second hydrogen/nitrogen fraction by splitting ammonia.

The storage tank connected to the second hydrogen/nitrogen source can be an ammonia storage means in which ammonia that can be released as a product can be temporarily stored before being used again. However, it is also possible to design the storage means as a separate buffer tank which only holds the ammonia intended for the formation of the second hydrogen/nitrogen fraction according to the invention.

It makes sense for the storage means connected to the second hydrogen/nitrogen source to be designed in such a way that the liquid ammonia can be stored at atmospheric pressure and temperatures of around −33° C. (±5° C.) or at higher temperatures and pressures above atmospheric pressure. Preferably, the storage means is made of a material that is resistant to corrosion by ammonia, at least if it is designed as a separate buffer tank.

The first hydrogen/nitrogen source can, for example, comprise an electrolyzer in which water can be split, in particular by proton-exchange-membrane electrolysis, alkali electrolysis or solid-oxide electrolysis, and a hydrogen fraction containing water can be obtained. To remove the interfering water in the ammonia synthesis gas, a dryer station is assigned to the electrolyzer, in which a largely water-free hydrogen fraction can be produced from the water-containing hydrogen fraction to form the first hydrogen/nitrogen fraction.

Preferably, the second hydrogen/nitrogen source comprises a cracking reactor which has a similar structure to a reactor known from the prior art for synthesis gas production by steam reforming hydrocarbons. Such a cracking reactor comprises a cracking furnace with colimators filled with catalyst material. The collimators are arranged in a combustion chamber, which is heated by one or more burners that supply energy for the endothermic cracking of the ammonia supplied through the collimators. The flue gases generated by the burners can only transfer a small proportion of their sensible heat to the colllimators, so that they leave the combustion chamber at a high temperature and with a large amount of residual heat. In order to carry out ammonia cracking efficiently, it is proposed that the cracking reactor is designed with a waste heat system in which at least one heat exchanger is arranged, via which heat can be extracted from the hot flue gases to preheat a feedstock, such as ammonia or burner air, or to generate steam.

It is also possible to heat the cracking furnace electrically.

Irrespective of the type of heating of the cracking reactor, the second hydrogen/nitrogen source usefully comprises at least one heat exchanger via which heat can be extracted from the cracked gas flowing out of the cracking reactor hot to preheat a feedstock, such as ammonia or burner air, or to generate steam.

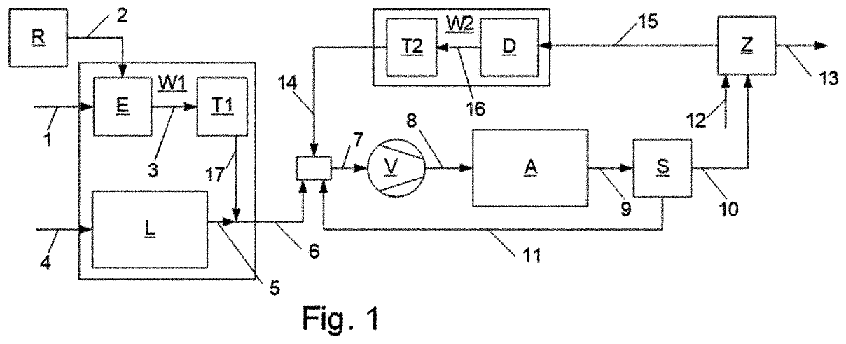

The invention will be explained in more detail below using an exemplary embodiment schematically illustrated in FIG. 1.

FIG. 1 shows a plant for producing ammonia, which can be operated in a preferred embodiment of the method according to the invention.

Water is supplied via line 1 to the electrolyzer E arranged in the first hydrogen/nitrogen source W1 in order to split it electrochemically into hydrogen and oxygen. The energy required for water splitting is supplied via electric current 2 with power that fluctuates over time from the energy source R, which is a wind or solar power plant, for example.

In addition to an oxygen fraction (not shown), a water-containing hydrogen fraction 3 can be extracted from the electrolyzer E with a likewise fluctuating flow rate and is supplied to the first dryer station T1 belonging to the first hydrogen/nitrogen source W1 to separate the water interfering with the ammonia synthesis. In the air separator L, which also belongs to the first hydrogen/nitrogen source W1, the nitrogen stream 5 is obtained from air 4 and combined with the hydrogen fraction 17 obtained largely free of water in the first dryer station T1 to form the first hydrogen/nitrogen fraction 6 and is used to form ammonia synthesis gas 7, in which hydrogen and nitrogen are present in the stoichiometric ratio of 3:1 for ammonia synthesis. After compression in compressor V, the ammonia synthesis gas is supplied via line 8 at a pressure of between 100 and 200 bar(a) to ammonia synthesis A, where it is converted with catalytic support in an exothermic reaction into a gas mixture 9, which, in addition to ammonia, also contains considerable amounts of hydrogen and nitrogen. At a temperature of between 40° and 450° C., the gas mixture 9 leaves the ammonia synthesizer A and is subsequently cooled in the separator S to separate ammonia 10 by condensation and obtain a recycled gas 11 consisting largely of hydrogen and nitrogen, which is recycled to increase the ammonia yield and used in the formation of the ammonia synthesis gas 7. Together with a small amount of water 12, the condensed ammonia 10 is supplied to the intermediate storage means Z, from which an ammonia product 13 can be drawn off.

If the electrical power that can be supplied from the energy source R is not sufficient to generate enough hydrogen in the first hydrogen/nitrogen source W1 to form ammonia synthesis gas 8 and to be able to supply it to the ammonia synthesis A at a flow rate that exceeds a minimum value required to maintain its normal reactor operation, the first hydrogen/nitrogen fraction 6 is supplemented by a second hydrogen/nitrogen fraction 14 such that the flow rate of the ammonia synthesis gas 8 is greater than this minimum value. The second hydrogen/nitrogen fraction 14 is produced from an ammonia fraction 15, which is taken from the intermediate storage means Z and supplied to the cracking reactor D arranged in the second hydrogen/nitrogen source W2. The ammonia contained in the ammonia fraction 15 is split to form hydrogen and nitrogen in an endothermic, preferably catalytically assisted reaction, while water, which also comprises the ammonia fraction 15, passes through the cracking reactor D unchanged. The resulting cracked gas 16, in which hydrogen and nitrogen are present in the stoichiometric ratio of 3:1 for the ammonia synthesis and which also contains unreacted ammonia and water, is supplied, to separate the water interfering with the ammonia synthesis, to the second dryer station T2 which belongs to the second hydrogen/nitrogen source W2 and in which the second hydrogen/nitrogen fraction 14 is formed.

1. A method for producing ammonia, in which a first hydrogen/nitrogen fraction is provided at a time-varying flow rate in order to form an ammonia synthesis gas which is converted to ammonia in an ammonia synthesis, wherein the first hydrogen/nitrogen fraction is supplemented by a second hydrogen/nitrogen fraction in such a way that, during normal operation, the ammonia synthesis gas can always be supplied to the ammonia synthesis at a flow rate which exceeds a predefined minimum value, wherein ammonia produced in the ammonia synthesis is transferred in liquid form to a storage means, from which ammonia is taken and split into hydrogen and nitrogen in order to obtain hydrogen and nitrogen so as to form the second hydrogen/nitrogen fraction.

2. The method according to claim 1, wherein the ammonia intended for the formation of the second hydrogen/nitrogen fraction is stored pressureless at temperatures below −33° C. or at higher temperatures and under pressure.

3. The method according to claim 1, wherein the ammonia intended for the formation of the second hydrogen/nitrogen fraction is taken from an ammonia storage means in which ammonia, which can be released as product, is temporarily stored prior to its further use.

4. The method according to claim 1, wherein the ammonia intended for the formation of the second hydrogen/nitrogen fraction is temporarily stored in a separate buffer tank independently of ammonia which can be released as product.

5. The method according to claim 1, wherein the ammonia taken from the storage means is converted, with or without catalytic support in an endothermic reaction in a cracking reactor, to a cracked gas containing hydrogen and nitrogen.

6. The method according to claim 5, wherein the cracked gas flowing from the cracking reactor hot is used to preheat the ammonia supplied to the cracking reactor and/or to generate steam.

7. The method according to claim 1, wherein a hydrogen fraction obtained by splitting water with the aid of an electrolyzer is used to form the first hydrogen/nitrogen fraction.

8. An apparatus for producing ammonia, having a first hydrogen/nitrogen source which provides a first hydrogen/nitrogen fraction at a time-varying flow rate in order to form an ammonia synthesis gas, an ammonia synthesis to which the ammonia synthesis gas can be supplied for conversion to ammonia, and a second hydrogen/nitrogen source, which can provide a second hydrogen/nitrogen fraction in order to supplement the first hydrogen/nitrogen fraction in such a way that, during normal operation, the ammonia synthesis gas can always be supplied to the ammonia synthesis at a flow rate which exceeds a predefined minimum value, wherein it comprises a storage means connected to the second hydrogen/nitrogen source, into which ammonia produced in the ammonia synthesis can be transferred in liquid form, and from which ammonia can be supplied to the second hydrogen/nitrogen source in order to obtain hydrogen and nitrogen so as to form the second hydrogen/nitrogen fraction by splitting ammonia.

9. The apparatus according to claim 8, wherein the storage means connected to the second hydrogen/nitrogen source is an ammonia storage means in which ammonia, which can be released as product, can be temporarily stored before its further use, or is a separate buffer tank which serves exclusively to store the ammonia which is to be supplied to the second hydrogen/nitrogen source.

10. The apparatus according to claim 9, wherein the storage means connected to the second hydrogen source is made of a material which is resistant to corrosion by ammonia.

11. The apparatus according to claim 8, wherein the first hydrogen/nitrogen source comprises an electrolyzer with which water can be split by proton-exchange-membrane electrolysis or alkali electrolysis or solid-oxide electrolysis and a water-containing hydrogen fraction can be obtained.

12. The apparatus according to claim 8, wherein the second hydrogen/nitrogen source comprises at least one heat exchanger via which heat can be extracted from the cracked gas flowing out of the cracking reactor hot to preheat a feedstock, such as ammonia or burner air, or to generate steam.

13. The apparatus according to claim 8, wherein the second hydrogen/nitrogen source comprises a cracking reactor comprising a cracking furnace which has cullimators filled with catalyst material and which can be heated via burners or electrically.
